(19) United States
(12) Patent Application Publication
(10) Pub. No.: US 2011/0196615 A1
(43) Pub. Date: Aug. 11, 2011

(54) Processing of biological signals

(75) Inventors: Andrea Lorenzo Vitali, Bergamo (IT); Alexandra Gogonea, Pavia (IT)

(73) Assignee: STMicroelectronics S.r.l., Agrate Brianza (IT)

(21) Appl. No.: 12/931,220

(22) Filed: Jan. 26, 2011

Related U.S. Application Data
(60) Provisional application No. 61/336,803, filed on Jan. 26, 2010.

(51) Int. Cl. G06F 19/00

(52) U.S. Cl. 702/19

(57) ABSTRACT

A method processes a signal by storing a template sequence composed of a number N of consecutive digital samples of the signal; calculating a sequence of extended sums that includes, for each digital sample, an extended sum of absolute values of differences between N most recent digital samples and the samples of the template sequence; detecting minima of the sequence of extended sums; and estimating a period of the signal as a time interval between two consecutive minima of the sequence of extended sums. The method also estimates the noise level of the signal as a ratio between most recently-detected minimum and maximum of said sequence of extended sums. The method also generates a reduced-noise replica of the signal as a weighted average of the template sequence and of the current samples of the signal processed between two consecutive minima of said extended sum, the weighted average being calculated using weights based on the estimated noise level.

### BACKGROUND

1. Technical Field

This disclosure relates to processing of biological signals and more particularly to a method of estimating the period of a biological signal, a method of estimating noise level corrupting a biological signal and a method of filtering from noise a biological signal.

2. Description of the Related Art

An important target of signal processing algorithms is the extraction of clinically significant information, like the period of the biological signals.

There are numerous algorithms for estimating the period of biological signals. Unfortunately, they are effective only if peculiar characteristics of the processed waveform are known in advance.

### BRIEF SUMMARY

It has been found a novel method of estimating the period of biological signals that does not require any preliminary assumption about the shape of the signal to be processed and thus may be used for determining the period of any kind of biologic signal.

According to an embodiment, adapted for a digital implementation of the method, a template sequence composed of a number N of consecutive samples of the biological signal are stored; then, for each incoming digital sample of the biological signal, an extended sum of the absolute values of the differences between the last N digital samples of the biological signal and the corresponding stored samples are calculated. The period of the biologic signal is estimated as the time interval between two consecutive minima of the sequence of extended sums.

According to another embodiment, the template sequence is updated with the last N digital samples of the biological signal every time a minimum of the sequence of extended sums is detected.

According to yet another embodiment, the number N of digital samples is chosen such to correspond to a maximum detectable period of the biological signal.

According to yet another embodiment, maximum and minimum values of the sequence of extended sums are detected through the following iterative procedure:

A) comparing a current sample with the previous sample in the sequence of samples of the biological signal, storing the greatest of the two,

B) if the current sample is smaller than the stored greatest sample diminished by a threshold, asserting the detection of a maximum equal to the stored value, updating said threshold and executing step C), otherwise repeating step A) for the next incoming sample;

C) comparing a current sample with the previous sample in the sequence of samples of the biological signal, storing the smallest of the two,

D) if the current sample, is larger than the stored smallest sample increased by a threshold, asserting the detection of a minimum equal to the stored value, updating said threshold and executing step A), otherwise repeating step C) for the next incoming sample.

This disclosure provides also a method of estimating noise level corrupting a biological signal, comprising the steps of:
estimating the period of the biological signal with the novel method; detecting maxima of the sequence of extended sums;
estimating the noise level as the ratio between the last detected minimum and maximum of the sequence of extended sums.

This disclosure provides also a method of filtering from noise a biological signal, comprising the steps of:
estimating noise level corrupting said biological signal with the novel method;
generating a noise free replica of the biological signal as a weighted average of the stored template sequence and of the current sequence of samples of the biological signal processed between the occurrence of the last two consecutive minima of the extended sum, the weights used for calculating the weighted average being defined as a function of the estimated noise level.

The novel method may be implemented with a software code executed by a computer or a microprocessor, or by any appropriately programmed controller or processor. The novel method may also be implemented with a dedicated hardware system.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

FIG. 1 is a flowchart of a method of estimating a period of a signal according to one embodiment of the present disclosure.

FIG. 2 compares waveforms of a biological signal corrupted by noise and the corresponding waveforms of the sum of absolute differences (SAD).

FIG. 3 compares waveforms of a biological signal affected by gain, offset, periodicity and shape fluctuations and the corresponding waveforms of the SAD.

FIG. 4 depicts the same waveforms of the biological signal of FIG. 2 normalized in the range −1, +1, and the corresponding waveforms of the SAD.

FIG. 5 is a flowchart of a method of generating a filtered signal from the incoming signal according to one embodiment.

FIGS. 6A and 6B depict two flow charts of as many embodiments of a novel method for identifying maxima and minima in a sequence of values.

FIG. 7 depicts graphs of a clean biological signal and of the corresponding SAD signal.

FIG. 8 depicts graphs of noise corrupted biological signal and corresponding SAD signal.

FIG. 9 is a block diagram of an electronic system according to one embodiment.

FIG. 10 is a block diagram showing a controller of the electronic system, according to one embodiment.

### DETAILED DESCRIPTION

The novel method is based on the use of a metric herein referred as sum of absolute differences (or, more briefly, SAD).

The sum of absolute differences (SAD) is a simple metric used for block-matching. It works by taking the absolute value of the difference between each element in the signal block referred to as a signal window and the corresponding element in the template block used for comparison. These differences are summed to create a simple metric of block similarity.

With Q and C being two sequences of a same length n:

Q=q₁, q₂, . . . qₙ

C=c₁, c₂, . . . , cₙ

the sum of absolute differences is defined as:

$$SAD = {\sum }_{i = 1}^{n} \vert {q}_{i} - {c}_{i} \vert$$

The SAD signal is computed considering a portion of the biological signal falling into a signal window of pre-established length, and a signal template representing at least one signal period.

### SAD Template Management

The SAD is computed between the signal template, initialized at zero; the template length is equal to the number of samples of the longest signal period, corresponding to the lowest detectable signal frequency. This initialization determines an initial transition phase. The template is compared with a signal window having the same length. The signal window is updated by substituting the oldest samples with the new ones (sliding window method).

Generally, the template length may be smaller than the period of the signal, as long as the signal waveform doesn't show any auto-similarity (blocks of the waveform are similar to the template).

The template may last longer than the signal period and also it may represent few periods: a higher length makes the SAD computation more noise-resilient, because the minimums are well distinguished from the maximums. However, if the template comprises just a few signal periods, the SAD computation may become less reliable (the difference between minimums and maximums is smaller): this transient state is typical of changes in adjacent waveforms or variable signal periods.

The template length may be adjusted with the detected period of the signal, but this may be an issue if the new period to identify is greater than the last one. As a matter of fact, in this case the template is smaller than the actual period of the signal, and the period can't be detected correctly.

Therefore the optimal choice is a constant template length, a fixed value which doesn't take into account possible changes in the period of the signal.

According to an embodiment, a constant length for the template is chosen, and the template values are updated each time a local minimum in the SAD is detected, tracking fluctuations in the signal waveform.

The SAD template is updated by computing the weighted average between the current SAD template and the sequence (current sequence) corresponding to the last minimum of SAD detected.

If there is no period identification for more than a maximum time interval (e.g. twice the template length), the algorithm and the SAD template are re-initialized. The new template values correspond to the last N signal samples, where N is the template length.

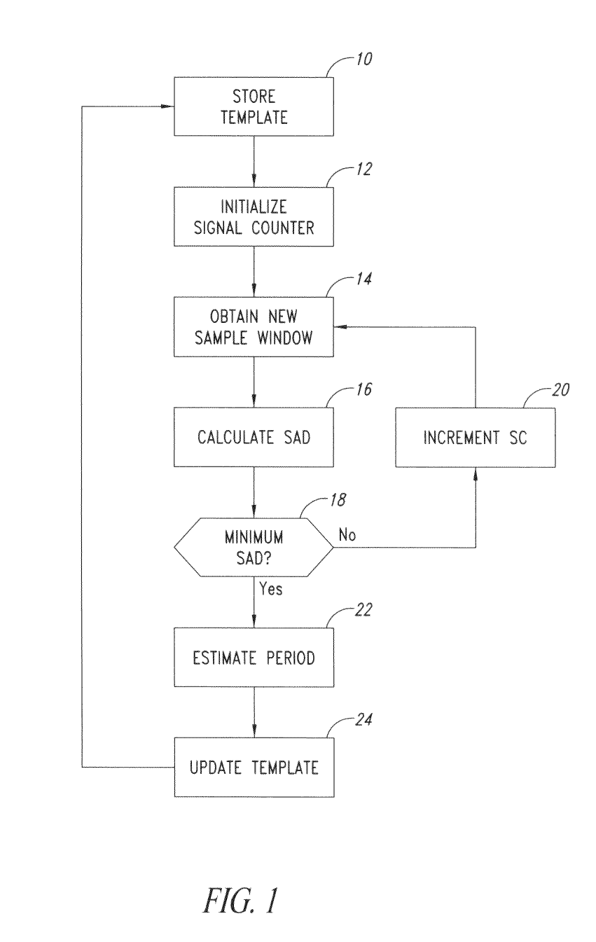

A flowchart of a method according to one embodiment of the present disclosure is shown in FIG. 1. The method begins by storing a template composed of a number N of consecutive samples of a biological signal (step 10). As discussed above, the number N of consecutive samples should be selected to represent at least one signal period, that is, the longest signal period desired to be detected.

In step 12, a sample count SC is initialized to zero. The sample count SC between consecutive minima will be the estimated period of the signal.

The method obtains a new sample window of N samples of the signal in step 14. In one embodiment, the samples in the sample window are the next N samples of the signal after the samples of the template. Alternatively, the samples of the sample window could overlap with the sample of the template or could be separated from the samples of the template by other samples of the signal.

In step 16, the method calculates the SAD of the sample window with respect to the template. That is, the method calculates the absolute values of the differences between the samples of the sample window and the corresponding stored samples of the stored template and sums those absolute values.

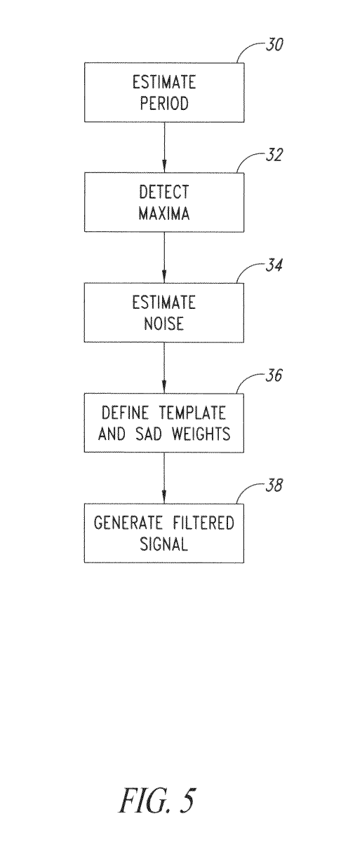

In step 18, the method determines whether the SAD calculated in step 16 is a minimum. This can be done by computing a sequence of SAD values for a sequence of sample windows and comparing each SAD value with adjacent SAD values of the sequence. Possible embodiments for detecting such minima are described below in connection with FIGS. 5A and 5B.

If the result of step 18 is negative, then the sample count SC is updated in step 20 and a new sample window is obtained by inputting the next sample into the previous sample window and deleting the oldest sample from the previous sample window. The SAD for the new sample window is calculated in step 16 and it is determined whether the SAD is a minimum in step 18.

If the result of step 18 is positive (a SAD minimum is found), the method generates an estimated period for the signal (step 20). In one embodiment, the estimated period is equal to the sample count SC.

The method then updates the stored template in step 24, reinitializes the sample count SC back to zero in step 12, and estimates a new period value in steps 14-22.

In one embodiment, the method estimates that the latest period value is a fixed period of the biological signal. Alternatively, one could estimate that the signal has a fixed period equal to an average (or various other functions) of the period values determined in each step 22.

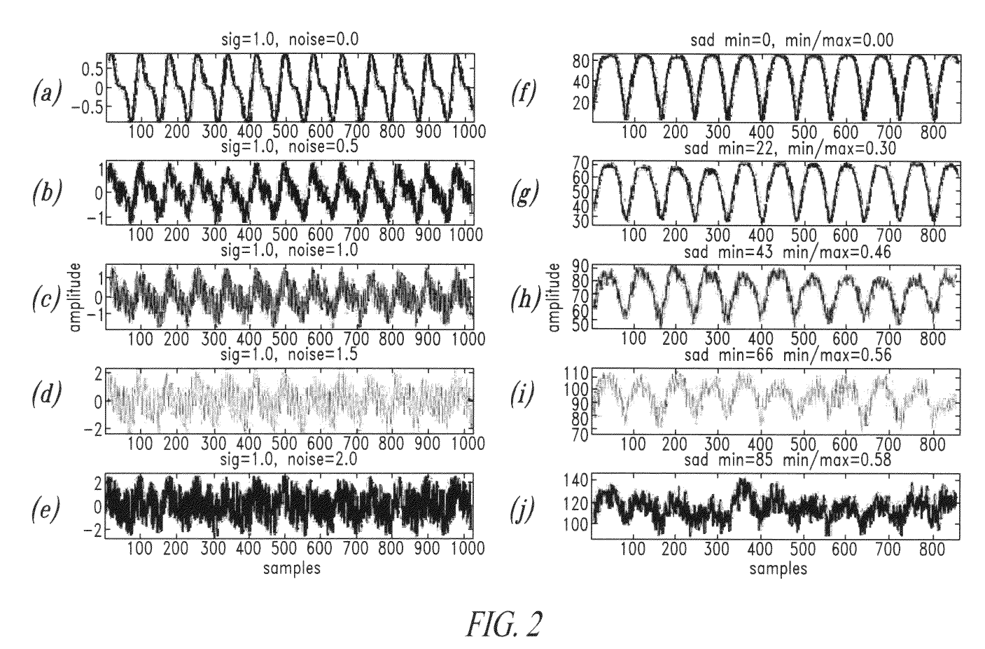

FIG. 2 depicts various biological signal waveforms (a)-(e) for various signal to noise levels and corresponding SAD waveforms (f)-(j). If the biologic signal is periodic with period N, the SAD is also a periodic signal having the same period.

The SAD signal exhibits a local minimum each time there is a high correlation between the template and the signal window corresponding to a waveform. The signal periodicity may be estimated by detecting a local minimum in the SAD; two adjacent minimums determine the signal period. The number of samples between the two minimums indicates the signal period N. Thus, this method permits the correct identification of the signal period without any previous information about the signal waveform.

As shown in FIG. 2 (waveform f), the value of the local minimum in the SAD is zero whenever the signal waveform repeats perfectly.

### Noise-Resistance

When the signal to noise ratio (SNR) decreases, the SAD values increase because the similarity between the template and the signal window decreases (FIG. 2). Even when the signal to noise ratio is very small (SNR=0.5) it's possible to identify the signal period because the SAD method is noise-resilient.

The SAD computation is particularly noise-resilient, because when the template chosen is longer than the length of the signal period, the minimums may be effectively distinguished from the maximums.

### Gain/Offset Compensation

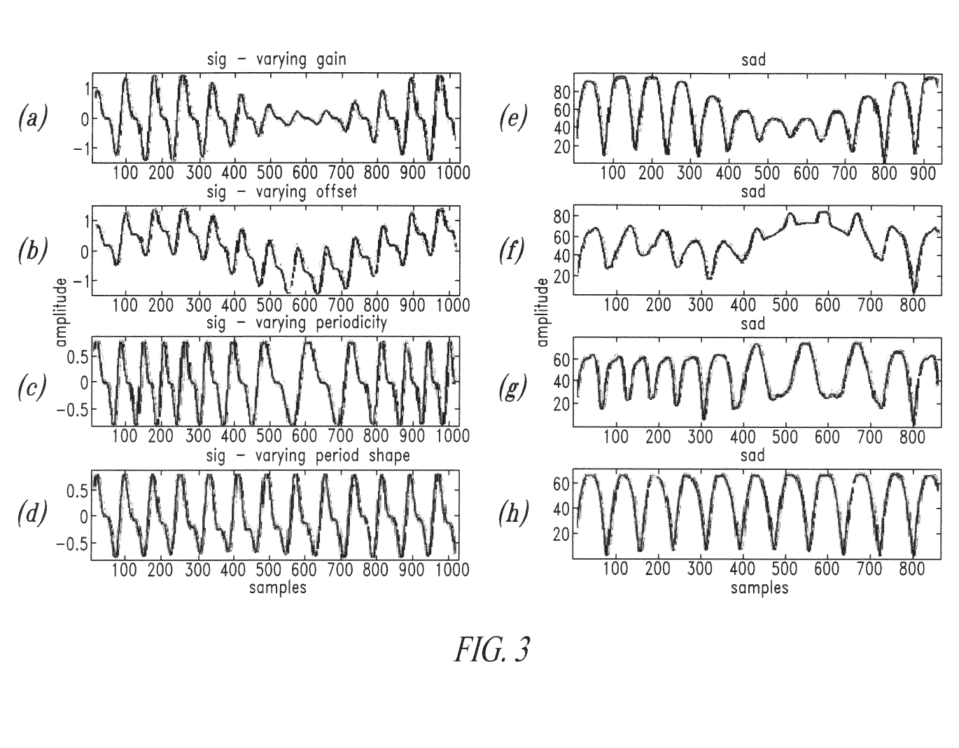

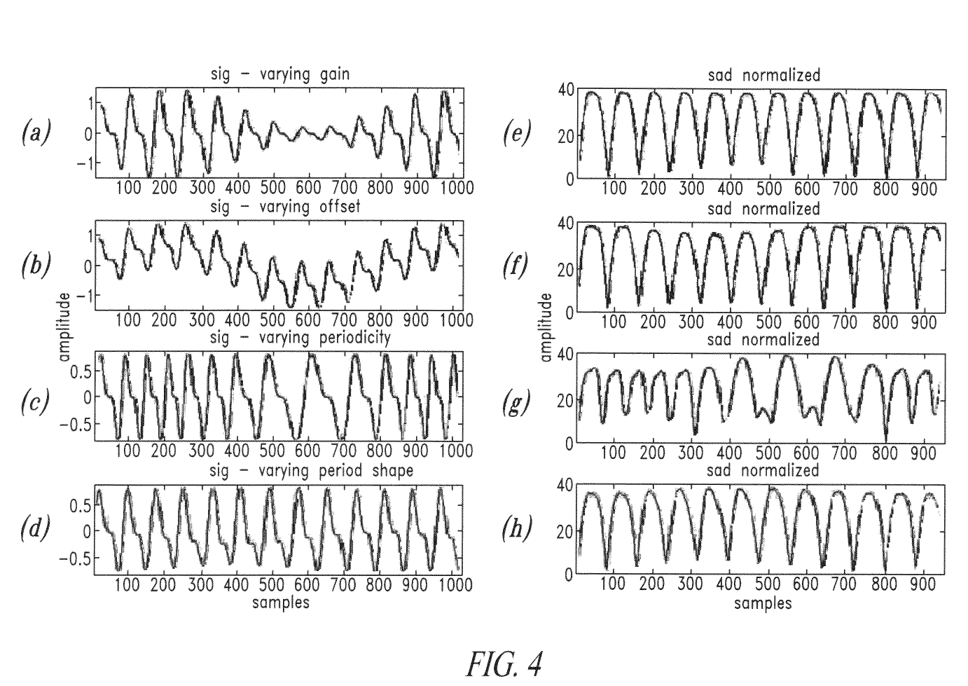

FIG. 3 depicts various biological signal waveforms (a-d) and corresponding SAD waveforms (e-h). Fluctuations in the signal amplitude (i.e. gain) (waveform (a), in the baseline (waveform (b), periodicity (waveform (d), or period shape (waveform (d) usually influence also the SAD amplitude, therefore the values of the local minimums increase (waveforms (e-h) in FIG. 3). In order to avoid this error, a normalized SAD (FIG. 4) is instead computed: the two sequences are normalized, so their values before the SAD computation range in the [0,1] interval. FIG. 4 depicts biological signal waveforms (a-d) that are the same as waveforms (a-d) of FIG. 3, and corresponding normalized SAD waveforms (e-h). Using the normalized SAD, an increase in the values of the local minimums occurs only when there is a change in the signal periodicity or in its waveform (waveforms (c-d) and (g-h) in FIG. 4).

### In-Band Noise Removal

In-band noise reduction exploits the detected signal periodicity. Noise removal is performed with a novel algorithm for reconstructing the signal using a weighted average operator, that is an improved version of the algorithm disclosed by Mannheimer et al. [1].

The incoming waveforms are broken into segments that correspond to the current signal period. The current period is detected using the algorithm described above.

After the periodicity detection, the segment corresponding to the current signal period (given by the signal samples between the current minimum of the SAD and the previous one) is selected, and the weighted average with the history of prior segments (averaged-waveform) is computed to create composite signals (clean signal); the average-waveform length is variable (whereas the SAD template length is fixed).

The weight is chosen on the basis of signal quality indicated by the noise level.

When the characteristics of the incoming signal point out that the signal may be distorted by interference, a higher weight is given to the prior composite signal in the averaging process, further reducing the influence of the interference. If the characteristics of the last period identified indicate that the signal quality is high, a higher weight is given to the incoming signal. It must be noted that the sum of the two weights is one, as they are complementary.

The parts of the waveform that are synchronous with the average signal period pass through this process unaffected, while the signal portions not occurring with the correct period are attenuated.

If the averaged-waveform and the segment corresponding to the current period don't have the same length, the averaged-waveform is warped to fit the most recent interval detected (segment corresponding to the current pulse) using Dynamic Time Warping, Derivative DTW [2] or another method that permits to find the correspondence between the elements of the two sequences.

### Noise Level Estimation

The weighted average logic utilized to update the SAD template and to attenuate the in-band noise is the same. The weight is chosen on the basis of the signal quality indicated by the noise level. The noise level is estimated taking into account the values of the local minimums of SAD.

The template weight is a and the current sequence weight is 1−α. When the incoming signal is clean, the current sequence weight is higher (a near to zero) than the template weight, but if the signal is corrupted the template weight (a near to one) is higher than the one for the current sample window.

The value of α ranges between 0 and 1 in this embodiment, so it is necessary to consider a normalized noise level comprised between 0 and 1.

The normalized noise level (NL) is estimated by the ratio between the value of the minimum of SAD and the corresponding maximum; the result is comprised between 0 and 1 because the value of the maximum can't be higher that the value of the minimum in this embodiment.

The value of the ratio is usually 0.6 for a low SNR signal, so we may define α=1.5 NL or 2 NL; however a must be comprised between 0 and 1 in this embodiment.

The weight may be comprised in an interval [low>0,high<1], chosen by the algorithm designer. This choice results in a slight update of the template, even if the signal is corrupted (high<1). If instead the signal is clean, the weight assigned to the past history of the signal is higher than zero, in order to take into account the past trend of the signal.

The same strategy is applied to the task of in-band noise attenuation: the weight 1−α is assigned to the segment corresponding to the current signal period and α to the averaged-waveform.

A method of generating a filtered signal from the incoming biological signal according to one embodiment is shown in FIG. 5. The method estimates the period of the biological signal in step 30 according to one of the methods described herein. The method detects maxima of the SAD signal in step 32 and estimates the noise level for each period in step 34. According to one embodiment, the noise level for a current period of the SAD signal is equal to a ratio of the minimum to the maximum for the selected period.

The method then defines the weight α for the averaged waveform and 1−α for the selected period in step 36. As discussed above, the weight α should be higher if the noise level for the current period is higher so that the portion of the filtered waveform to be produced for the current period is more heavily influenced by the averaged waveform for the previous periods. Conversely, the weight α should be lower if the noise level for the current period is lower so that the portion of the filtered waveform to be produced for the current period is less heavily influenced by the averaged waveform for the previous periods.

In step 38, the method generates the filtered signal comprised of the weighted-average waveforms for the periods of the SAD signal.

It will be appreciated that the steps 30-38 are not necessarily performed in the sequence depicted in FIG. 5. For example, the maxima detection step 32 can be performed concurrently with the detecting minima step of the period estimation step 30. Also, all of the steps 32-38 could be performed after the entire SAD signal is generated or those steps could be performed along with the period estimating step 30 one signal period at a time.

### Peak Identification

One method that may be used for the peaks identification is the one proposed by Todd & Andrews [3]. We give here a brief description about the algorithm.

The algorithm detects peak (P) and through (T) elements of the biological signal (Q). A local variable i is used as an index into Q, counting from the first element to the last element. The variable d indicates the direction of the signal:

d=↑ proceeding from a trough to a peak;

d=↓ proceeding from a peak to a trough;

d=? direction indeterminate.

Variable a records the index of a maximal element since the last trough. Correspondingly, variable b records the index of a minimal element since the last peak. Variable S records the indices of the maximal elements since the last trough if the signal is rising (d=↑) or those of the minimal elements since the last peak if the signal is falling (d=↓). The threshold 8 is assumed to be a fixed global constant.

To understand how the algorithm works, for example consider the case when the current direction of the signal is up (d=↑). If the current element Q[i] is strictly greater than the previous highest level Q[a] since the last trough then both S and a are updated. If the current element is equal to the previous highest level then it is too maximal and its index is added to the other in S. If the current element is strictly less than the previous highest then no action is taken unless the current element is δ or more below the previous highest. In the last case the current element is dominated by all the members of S which are all equivalent peak elements since they also dominate at least one previous through element. A peak having now been passed, the direction d is reversed and the current element is the unique minimal element since the last peak. The algorithm thus continues to alternate between peak and trough detection. This oscillatory process begins immediately when an element is encountered that is at least δ above or below some previous element. The authors indicate that parameter δ should be set to the height of the smallest peak or through that should be detected.

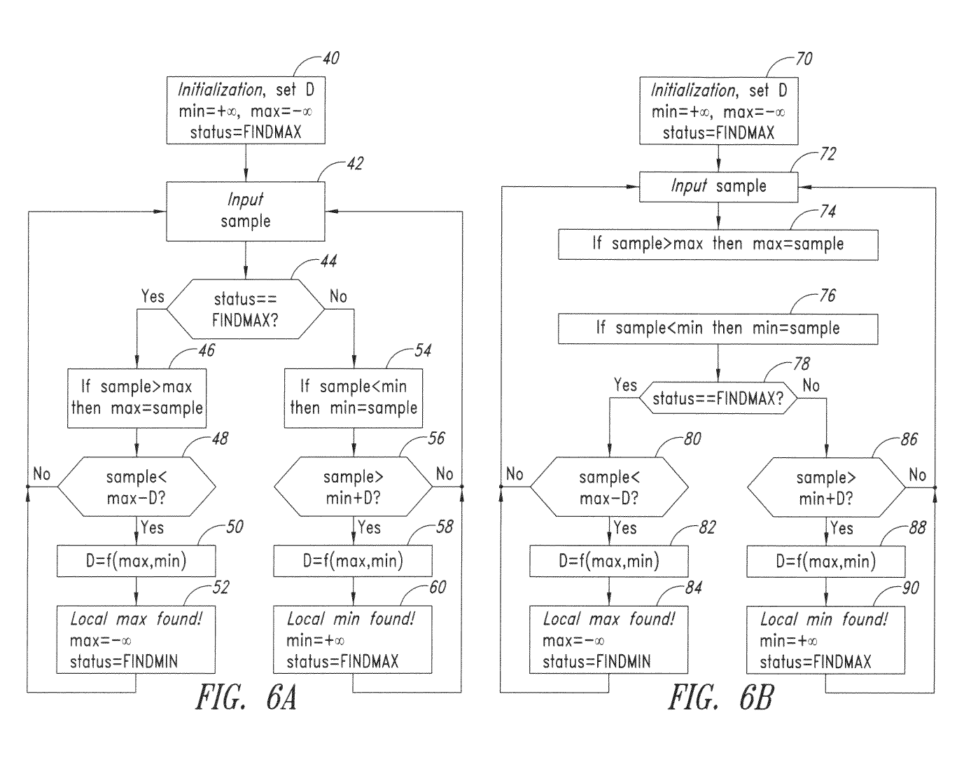

We conveniently modified their algorithm as shown in FIG. 6A. We assume that the state variable (named d in the original version of the algorithm) may take only two logic values (FINDMAX, FINDMIN) which indicates that we are searching for a maximum or for a minimum. Furthermore we consider an automatic threshold (D, named δ in the original version) update, to adapt to the characteristics of the signal.

The method of FIG. 6A includes an initialization step 40 that initializes the threshold D, and the minimum and maximum variables min, max, and sets the status to the FINDMAX state. The method inputs a sample of the biological signal in step 42 and determines whether the status is FINDMAX in step 44. Given that the status initially is FINDMAX, the method determines whether the sample is less than max, and if so, sets max equal to the sample value in step 46. Given that max is initially set to −∞, step 46 sets max equal to the first sample. In step 48, the method determines whether the sample value is less than max minus D. If the answer is no, which is initially the case, the method returns to repeat steps 42-48 for the next sample. The process keeps repeating for new samples until the current sample is determined to be less than max-D in step 48. In that case, D is updated in step 50, which is explained more fully below. In step 52, the sample corresponding to max is asserted to be a local maximum, max is reset to −∞, and the status indicator is set to FINDMIN in order to search for a minimum of the samples of the biological signals.

The method obtains a new sample in step 42 and determines in step 44 that the status is no longer FINDMAX. As a result, the method determines in step 54 whether the new sample is less than min, and if so, sets min equal to the sample value. Given that min is initially set to ∞ in step 40, min will be updated to equal the sample value in step 54. In step 56, the method determines whether the sample value is greater than min plus D. If the answer is no, which is initially the case, the method returns to repeat steps 42, 44, 54, and 56 for the next sample. The process keeps repeating for new samples until the current sample is determined to be greater than min+D in step 56. In that case, D is updated in step 58, which is explained more fully below. In step 60, the sample corresponding to min is asserted to be a local minimum, min is reset to ∞, and the status indicator is set to FINDMAX in order to search for the next maximum.

In FIG. 6A only the searched deflection is updated: max if we are searching for a maximum, min if we instead are searching for a minimum. FIG. 6B shows an alternate embodiment in which max or min are updated at every loop.

In particular, the method of FIG. 6B starts with an initialization step 70 and an input sample step 72 that are identical to the initialization step 40 and input sample step 42, respectively, of FIG. 6A. Next, instead of the status check step 44, the method of FIG. 6b determines with the sample value is greater than max, and if so, sets max equal to the sample value in step 74. The method also determines in step 76 whether the new sample is less than min, and if so, sets min equal to the sample value. Given that min is initially set to ∞ and max is initially set to −∞ in step 70, max will be updated to the sample value in step 74 and min will be updated to equal the sample value in step 76.

The method then determines in step 78 whether the status is FINDMAX. Given that the status initially is FINDMAX, the method determines in step 80 whether the sample value is less than max minus D. If the answer is no, which is initially the case, the method returns to repeat steps 72-80 for the next sample. The process keeps repeating for new samples until the current sample is determined to be less than max-D in step 80. In that case, D is updated in step 82, and in step 84, the sample corresponding to max is asserted to be a local maximum, max is reset to −∞, and the status indicator is set to FINDMIN in order to search for a minimum of the samples of the biological signals.

The method obtains a new sample in step 72, determines in step 74 whether the new sample value is greater than max, and determines in step 76 whether the new sample is less than min. Given that max was reset to −∞ in step 84, max will be updated to equal the sample value in step 74. Given that min was set to the lowest sample value in step 76 prior to the local max found in step 80, it is unlikely that min will be set to the new sample value in step 76.

Next, the method determines in step 78 that the status is no longer FINDMAX. As a result, the method determines in step 86 whether the new sample is greater than min plus D. If the answer is no, the method returns to repeat steps 72-78 and 86 for the next sample. The process keeps repeating for new samples until the current sample is determined to be greater than min+D in step 86. In that case, D is updated in step 88, and in step 90 the sample corresponding to min is asserted to be a local minimum, min is reset to ∞, and the status indicator is set to FINDMAX in order to search for the next maximum. In both of the embodiments of FIGS. 6A and 6B, the threshold D is updated after each peak identification. The minimum threshold value is Dmin and can't be zero. The maximum threshold value that allows peak identification with noise rejection is the distance (amplitude) between the local maximum (max) and local minimum (min); the default value is thdiffp×(max−min), where thdiffp is the weight, and it may be at most 1 assuming that normalized sample values are input (for example we choose thdiffp equal to 0.2 or 0.5).

The value of the rejected noise may be at most equal to the threshold chosen; that's why the threshold should be the greatest possible, but it should be less than the difference between maximum and minimum, otherwise it is not possible to identify the peaks.

Generally, the threshold is given by the maximum value between Dmin, thdiffp×(max−min) and thdminp×min, where thdminp is the weight of the local minimum (for example we choose thminp equal to 0.2 or 0.5).

We consider also thdminp×min because the value of the minimum is related to the signal noise level (a high value of the minimum points out that the signal is affected by noise or that the waveform similarity is low).

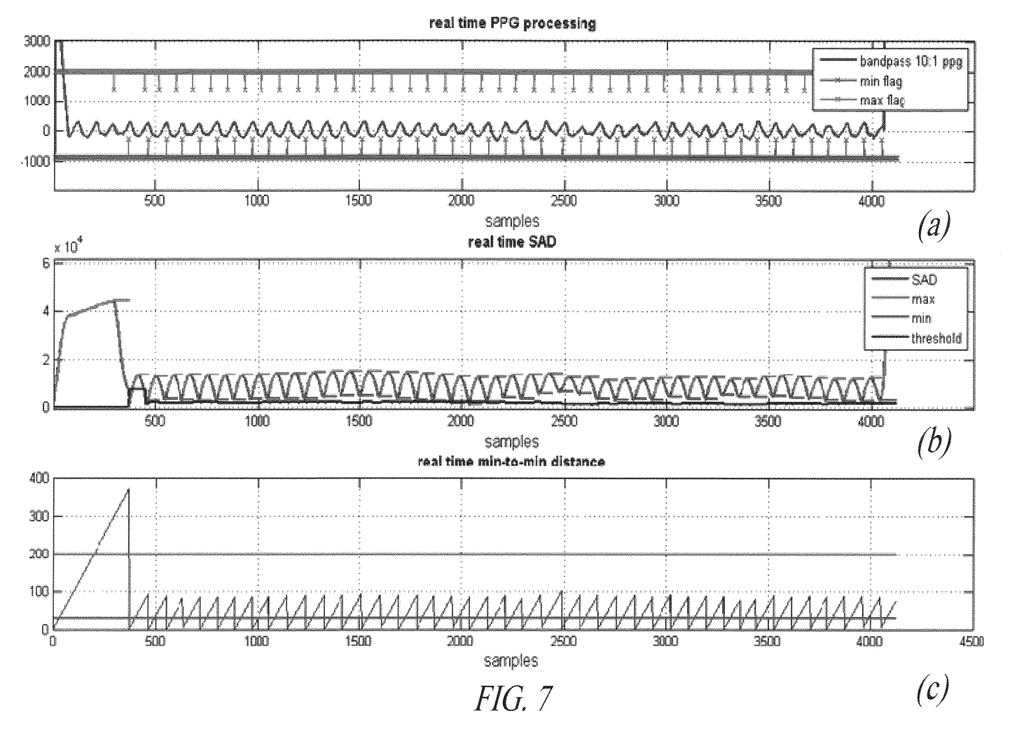

FIG. 7 shows a clean signal in waveforms (a), the SAD signal in waveforms (b), and real time distances between minima in waveforms (c). Notice that the SAD signal has a nearly periodic trend and the values of the minima are pretty small. Also the amplitude of the SAD is quite constant. Notice few variations of the SAD trend corresponding to the signal window having different waveforms.

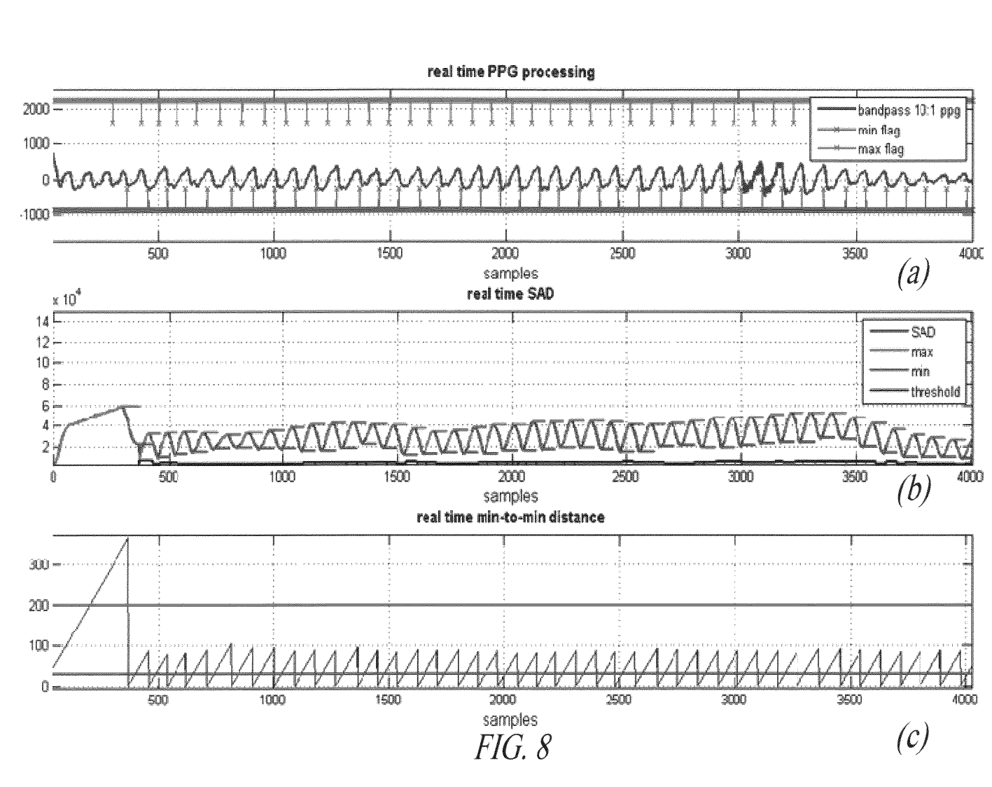

Considering a noise corrupted signal, as shown in waveforms (a) of FIG. 8, which also shows in corresponding SAD signal in waveforms (b), and real time distances between minima in waveforms (c). The SAD signal varies and the values of the minima increase.

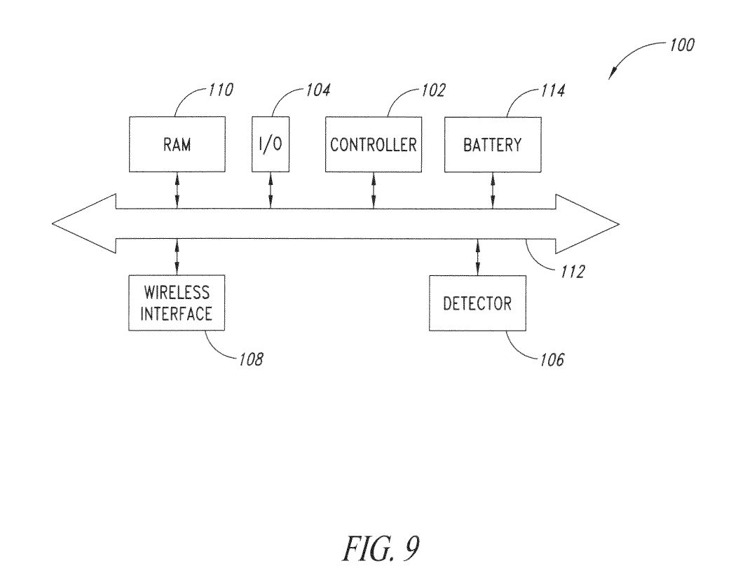

FIG. 9 shows a portion of an electronic system 100, according to an embodiment that is configured to implement the method described above. The electronic system 100 can be used in electronic devices, such as for example: a portable or fixed computer, possibly with wireless data-transfer capacity; or further devices able to process, store, transmit and receive information.

In detail, the electronic system 100 comprises: a controller 102 (for example, provided with a microprocessor, a DSP, a microcontroller, or a hardwired controller); an input/output device 104 (for example, provided with a keypad and a display), for input and display of data; a detector 106 for producing the biological signal based on a biological detection; a wireless interface 108, for example, an antenna, for transmitting and receiving data through a radiofrequency wireless communication network; and a memory 110, all coupled through a bus 112. A battery 114 can be used as electrical-supply source in the electronic system 100. The controller 102 is appropriately configured, such as via programming or hardwiring, to implement the methods described above.

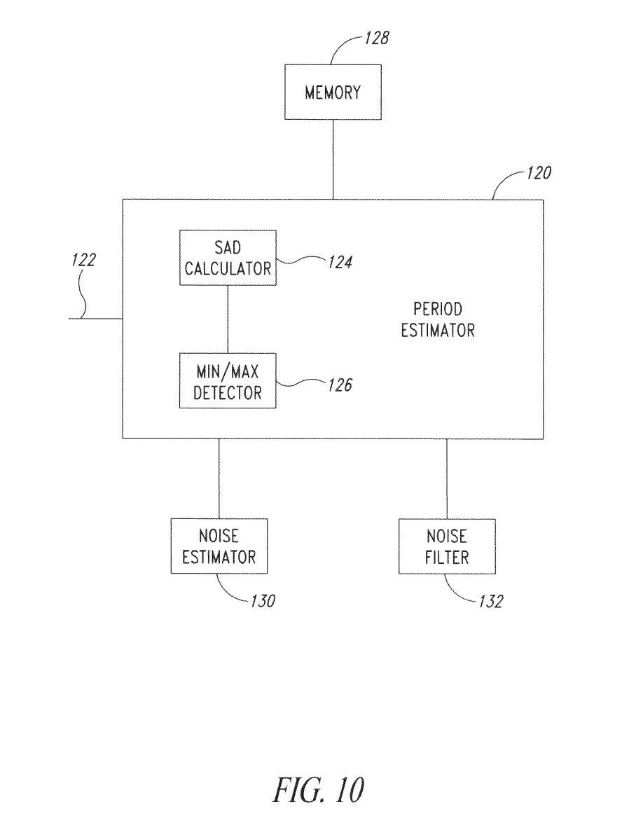

In one embodiment shown in FIG. 10, the controller 102 includes a period estimator 120 having an input 122 for receiving the digital samples of the biological signal. The digital samples may be received directly from a digital sampler (not shown) coupled to the detector 106 or from a memory such as the memory 110 of FIG. 9. The period estimator 120 is configured to perform the method described above for estimating the period of the biological signal and includes a SAD calculator 124 configured to generate the SAD signal and a min/max detector 126 configured to detect the minima and maxima of the SAD signal, as described above. The period estimator 120 is coupled to a memory 128 that could be an internal memory of the controller 102, the memory 110 of the system 100 of FIG. 9, or any other storage element configured to store the template, the current samples, and any variables used by the period estimator 120. The controller also includes a noise estimator 130 configured to estimate the noise of the biological signal as discussed above and a noise filter configured to generate the reduced-noise replica of the biological signal as discussed above.

The various embodiments described above can be combined to provide further embodiments. All of the U.S. patents, U.S. patent application publications, U.S. patent applications, foreign patents, foreign patent applications and non-patent publications referred to in this specification are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

### BIBLIOGRAPHY

1. Mannheimer P. D., Baker C. R., Nellcor Technical Staff. Digital Signal Processing Technology in Nellcor OxiMax Pulse Oximeters.
2. Keogh E. J., Pazzani M. J. Derivative Dynamic Time Warping.
3. Todd B. S., Andrews D. C. The Identification of Peaks in Physiological Signals. Computers and Biomedical Research 32, 322-335, 1999.

1. A method of processing a biological signal, comprising:
storing a template sequence composed of a number N of consecutive digital samples of the biological signal;
calculating a sequence of extended sums, the sequence of extending sums including, for each incoming digital sample of the biological signal, an extended sum of absolute values of differences between N most recent digital samples of the biological signal and the stored samples of the template sequence;
detecting minima of the sequence of extended sums;
generating an estimation of a period of the biological signal as a time interval between two consecutive minima of the sequence of extended sums.

2. The method of claim 1, comprising updating the template sequence with the N most recent digital samples of the biological signal in response to detecting each of the minima of the sequence of extended sum.

3. The method of claim 1, comprising choosing the number N of digital samples to correspond to a maximum detectable period of the biological signal.

4. The method of claim 1, comprising scaling down the digital samples of the biological signal by a factor in a range from 0 to 1 before calculating the extended sum.

5. The method of claim 1, further comprising:
estimating noise level corrupting the biological signal, the estimating including:
detecting maxima of said sequence of extended sums;
estimating said noise level as a ratio between most recently-detected minimum and maximum of said sequence of extended sums.

6. The method of claim 5, wherein:
detecting the maxima of the sequence includes:
comparing a current sample with a previous greatest sample in the digital samples of the biological signal;
setting the current sample to be a new greatest sample if the current sample is greater than the previous greatest sample; and
if the current sample is smaller than previous greatest sample diminished by a threshold, detecting that the previous greatest sample is a maximum of the sequence and updating said threshold, otherwise repeating the comparing for a next incoming sample; and
detecting the minima of said sequence includes:
comparing a current sample with a previous smallest sample in the sequence of samples of the biological signal;
setting the current sample to be a new smallest sample if the current sample is less than the previous smallest sample; and
if the current sample is larger than the previous smallest sample increased by the threshold, detecting that the previous smallest sample is a minimum of the sequence and updating said threshold, otherwise repeating the comparing and setting of the step of detecting the minima for the next incoming sample.

7. The method of claim 5, further comprising:
filtering noise from the biological signal, the filtering including:
generating a reduced-noise replica of the biological signal as a weighted average of the stored template sequence and of the current sequence of samples of the biological signal processed between two consecutive minima of said extended sum, the weighted average being calculated using weights defined in function of the estimated noise level.

8. The method of claim 7, wherein the weights include:
a first weight of said current sequence of samples that is proportional to said noise level and ranges between 0 and 1, and
a second weight of said stored template sequence that is 1 minus the first weight.

9. The method of claim 1, wherein detecting the minima of said sequence includes:
comparing a current sample with a previous smallest sample in the sequence of samples of the biological signal;
setting the current sample to be a new smallest sample if the current sample is less than the previous smallest sample; and
if the current sample is larger than the previous smallest sample increased by the threshold, detecting that the previous smallest sample is a minimum of the sequence and updating said threshold, otherwise repeating the comparing and setting of the step of detecting the minima for the next incoming sample.

10. A computer readable memory medium storing instructions configured to cause a computer to execute a method that includes:
storing a template sequence composed of a number N of consecutive digital samples of the biological signal;
calculating a sequence of extended sums, the sequence of extending sums including, for each incoming digital sample of the biological signal, an extended sum of absolute values of differences between N most recent digital samples of the biological signal and the stored samples of the template sequence;
detecting minima of the sequence of extended sums;
generating an estimation of a period of the biological signal as a time interval between two consecutive minima of the sequence of extended sums.

11. The computer readable memory medium of claim 10, wherein the method includes updating the template sequence with the N most recent digital samples of the biological signal in response to detecting each of the minima of the sequence of extended sum.

12. The computer readable memory medium of claim 10, wherein the method includes scaling down the digital samples of the biological signal by a factor in a range from 0 to 1 before calculating the extended sum.

13. The computer readable memory medium of claim 10, wherein the method includes:
estimating noise level corrupting the biological signal, the estimating including:
detecting maxima of said sequence of extended sums;
estimating said noise level as a ratio between most recently-detected minimum and maximum of said sequence of extended sums.

14. The computer readable memory medium of claim 13, wherein:
detecting the maxima of the sequence includes:
comparing a current sample with a previous greatest sample in the digital samples of the biological signal;
setting the current sample to be a new greatest sample if the current sample is greater than the previous greatest sample; and
if the current sample is smaller than previous greatest sample diminished by a threshold, detecting that the previous greatest sample is a maximum of the sequence and updating said threshold, otherwise repeating the comparing for a next incoming sample; and
detecting the minima of said sequence includes:
comparing a current sample with a previous smallest sample in the sequence of samples of the biological signal;
setting the current sample to be a new smallest sample if the current sample is less than the previous smallest sample; and
if the current sample is larger than the previous smallest sample increased by the threshold, detecting that the previous smallest sample is a minimum of the sequence and updating said threshold, otherwise repeating the comparing and setting of the step of detecting the minima for the next incoming sample.

15. The computer readable memory medium of claim 13, wherein the method includes:
filtering noise from the biological signal, the filtering including:
generating a reduced-noise replica of the biological signal as a weighted average of the stored template sequence and of the current sequence of samples of the biological signal processed between two consecutive minima of said extended sum, the weighted average being calculated using weights defined in function of the estimated noise level.

16. The computer readable memory medium of claim 10, wherein detecting the minima of said sequence includes:
comparing a current sample with a previous smallest sample in the sequence of samples of the biological signal;
setting the current sample to be a new smallest sample if the current sample is less than the previous smallest sample; and
if the current sample is larger than the previous smallest sample increased by the threshold, detecting that the previous smallest sample is a minimum of the sequence and updating said threshold, otherwise repeating the comparing and setting of the step of detecting the minima for the next incoming sample.

17. A system configured to process a biological signal, comprising:
a memory configured to store a template sequence composed of a number N of consecutive digital samples of the biological signal;
an extended sum calculator configured to calculate a sequence of extended sums, the sequence of extending sums including, for each incoming digital sample of the biological signal, an extended sum of absolute values of differences between N most recent digital samples of the biological signal and the stored samples of the template sequence;
a minima detector configured to detect minima of the sequence of extended sums;
a period estimator configured to generate an estimation of a period of the biological signal as a time interval between two consecutive minima of the sequence of extended sums.

18. The system of claim 17, wherein the period estimator is configured to update the template sequence with the N most recent digital samples of the biological signal in response to the minima detector detecting each of the minima of the sequence of extended sum.

19. The system of claim 17, wherein the period estimator is configured to scale down the digital samples of the biological signal by a factor in a range from 0 to 1 before the extended sum calculator calculates the extended sum.

20. The system of claim 4-617, comprising:
a maxima detector configured to detect maxima of said sequence of extended sums; and
a noise estimator configured to estimate a noise level of the biological signal as a ratio between most recently-detected minimum and maximum of said sequence of extended sums.

21. The system of claim 20, wherein:
the maxima detector is configured to:
compare a current sample with a previous greatest sample in the digital samples of the biological signal;
set the current sample to be a new greatest sample if the current sample is greater than the previous greatest sample; and
if the current sample is smaller than previous greatest sample diminished by a threshold, detect that the previous greatest sample is a maximum of the sequence and update said threshold; and
the minima detector is configured to:
compare a current sample with a previous smallest sample in the sequence of samples of the biological signal;
set the current sample to be a new smallest sample if the current sample is less than the previous smallest sample; and
if the current sample is larger than the previous smallest sample increased by the threshold, detect that the previous smallest sample is a minimum of the sequence and update said threshold.

22. The system of claim 21, comprising:
a noise filter configured to filter noise from the biological signal and generate a reduced-noise replica of the biological signal as a weighted average of the stored template sequence and of the current sequence of samples of the biological signal processed between two consecutive minima of said extended sum, the weighted average being calculated using weights defined in function of the estimated noise level.

23. The system of claim 17, wherein the minima detector is configured to:
compare a current sample with a previous smallest sample in the sequence of samples of the biological signal;
set the current sample to be a new smallest sample if the current sample is less than the previous smallest sample; and
if the current sample is larger than the previous smallest sample increased by the threshold, detect that the previous smallest sample is a minimum of the sequence and update said threshold.
